(19) United States
(12) Patent Application Publication
(10) Pub. No.: US 2018/0329629 A1
(43) Pub. Date: Nov. 15, 2018

(54) DATA WIPING OF SOLID-STATE DRIVES

(71) Applicant: WipeOS LLC, Eden Prairie, MN (US)

(72) Inventor: Ridvan Hajrullahu, Blaine, MN (US)

(21) Appl. No.: 15/592,876

(22) Filed: May 11, 2017

(51) Int. Cl. G06F 3/06; G06F 12/1018

(52) U.S. Cl. CPC G06F 3/0604; G06F 3/0688; G06F 3/0652; G06F 12/1018; G06F 3/0659; G06F 3/061

(57) ABSTRACT

Data is wiped from a solid-state drive (SSD). Properties of the SSD, including page size of the SSD, are determined. A pseudo-random number generator (PRNG) is initialized with a first seed value. Random-like data is generated as output of the PRNG. Write commands are sent to the SSD to write the output of the PRNG while ensuring that each of the write commands contains at least one page of PRNG output to be written to the SSD that is different from any previously-written page of PRNG output to the SSD.

### TECHNICAL FIELD

Embodiments described herein generally relate to information processing and security and, more particularly, to recycling or refurbishment of solid-state drives with complete and assured removal of stored data.

### BACKGROUND

Recycling of a disk drive involves taking steps to ensure that all prior data is irretrievably removed from the drive. To assure complete removal of previous data, it is insufficient to perform a basic “erase” or “format drive” operation; these actions typically leave much of the previous data on the storage media. Accordingly, specialized data wiping processes have been developed. Data wiping generally entails writing random, or random-looking, data over the entire drive, with multiple passes.

Solid-state drives (SSDs) are flash memory-based storage devices that interface with their host computers in a manner similar to traditional HDDs. Advantageously, SSDs have no moving parts, and offer superior performance, particularly in data-reading operations. As the popularity of SSDs in consumer- and business-grade computer systems has grown, so too has the need for recycling or refurbishing SSDs.

Data wiping of traditional spinning-platter hard disk drives (HDDs) is a relatively straight-forward operation as the data, once written, remains in its original location on the storage media. The same cannot be said of SSDs. SSDs read, write, and erase the data-storage media using very different operating principles. In a SSD, portions of the stored data tend to be moved about the storage media, and the SSD strives to avoid erasing and re-writing data whenever possible using various optimization algorithms. From the perspective of a data-wiping system, SSDs present particular challenges to ensuring completeness of the data removal since the internal workings of the SSD are not controllable or accessible to the data-wiping system.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1A is a high-level system diagram illustrating an example of a SSD wiping system according to some embodiments.

FIG. 1B is a simplified diagram illustrating the basic architectural organization of an SSD according to an example.

FIG. 1C is a flow diagram illustrating an example of storage and performance optimization in SSDs.

FIG. 2 is a block diagram illustrating a basic architecture of a computing platform in the example form of a general-purpose machine on which aspects of the embodiments may be implemented.

FIG. 3 is a diagram illustrating an exemplary hardware and software architecture of a computing device such as the one depicted in FIG. 2, in which various interfaces between hardware components and software components are shown.

FIG. 4 is a block diagram illustrating processing devices of the computing device architecture of FIG. 3 according to some embodiments.

FIG. 5 is a block diagram illustrating example components that may be implemented on a computer system, such as the computer system and components described with reference to FIGS. 2-4, according to various embodiments.

FIG. 6 is a flow diagram illustrating an example process for wiping a SSD, which may be carried out by drive wiping system of FIG. 5 according to some embodiments.

FIG. 7 is a flow diagram illustrating operation of a pseudo random number generator (PRNG) in a SSD wiping process, including an example of ensuring that each page written to the SSD is unique, according to an embodiment.

FIG. 8 is a flow diagram illustrating another example operation of a PRNG according to some embodiments, in which the PRNG does not require a particularly long period, or other properties, to inherently ensure that pages of random-like data are not repeated.

### DETAILED DESCRIPTION

Aspects of the embodiments are directed to systems and methods for data wiping that are applicable to SSDs as well as to HDDs. Although embodiments described below offer technological solutions to challenges that may be specific to SSDs, it should be understood that principles of the embodiments may be used to some advantage in a variety of other applications. In this description, for the sake of brevity, the example embodiments are described in the context of SSD wiping.

As will be described in greater detail below, a system for data wiping of SSDs may be implemented in a computer system. The computer system may be one physical machine, or may be distributed among multiple physical machines, such as by role or function, or by process thread in the case of a cloud computing distributed model. In various embodiments, certain operations may run in virtual machines that in turn are executed on one or more physical machines. It will be understood by persons of skill in the art that features of the invention may be realized by a variety of different suitable machine implementations.

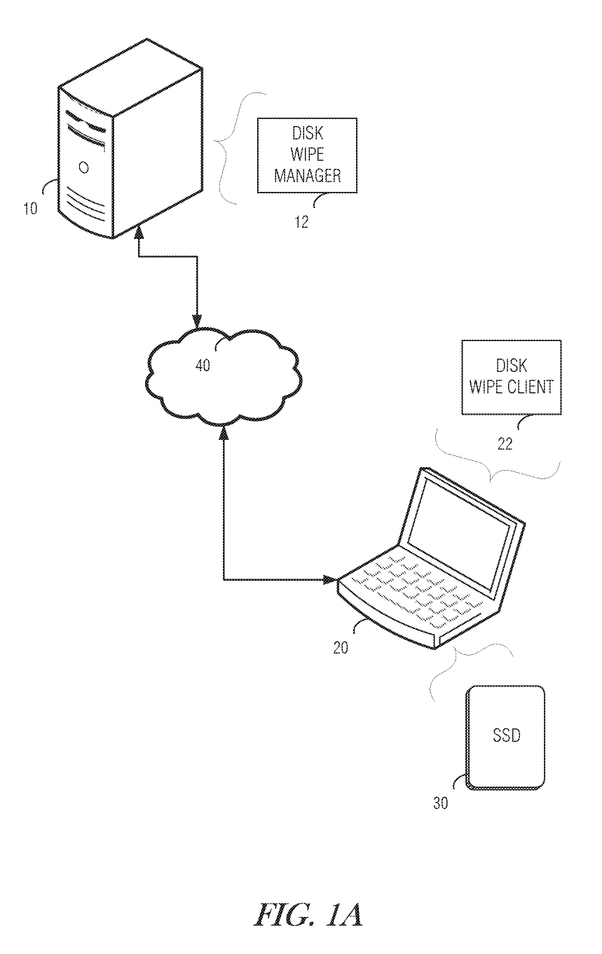

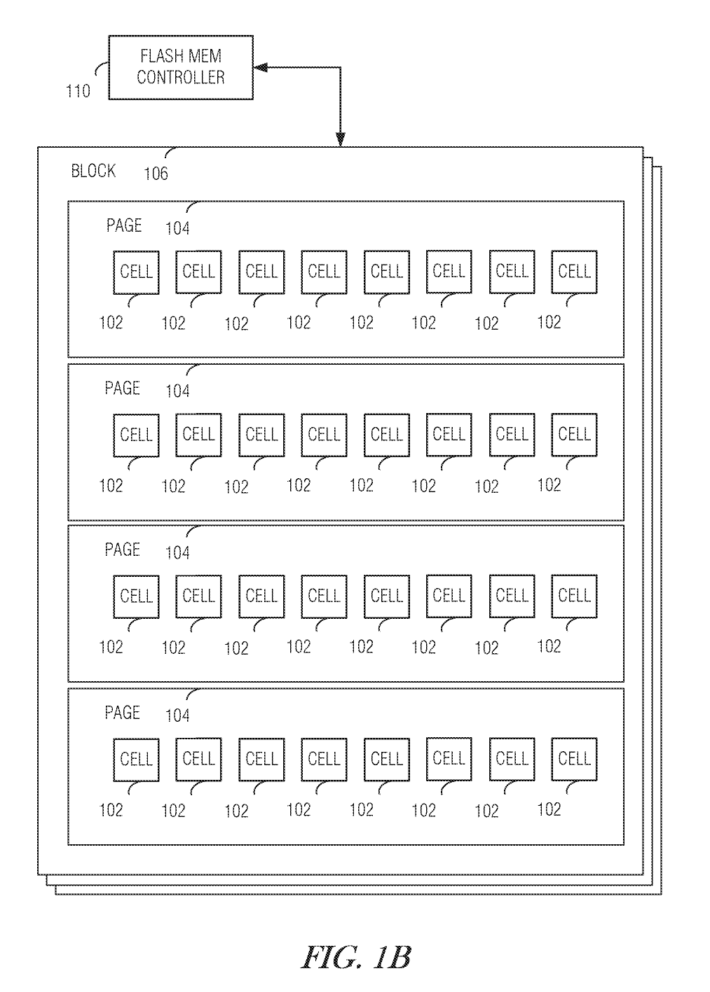

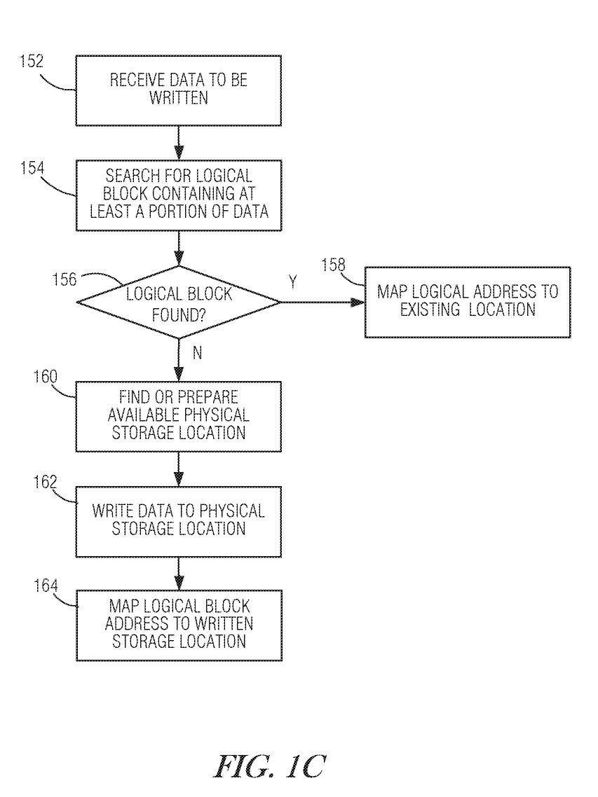

FIG. 1A is a high-level system diagram illustrating an example of a SSD wiping system according to some embodiments. The system includes server 10 configured to run disk wipe manager application 12 that, when executed, transforms server 10 into a special-purpose machine that commands one or more host machines, such as host machine 20, to wipe installed SSD 30. Host machine 20 runs disk wipe client program 22 that, when executed, transforms host machine 20 into a special-purpose machine for wiping SSD 30. Disk wipe client program 22 may be a system-level software program that implements a specialized operating system on host machine 20 that resides entirely in the memory of host machine 20. Server 10 may be communicatively interfaced with host machine 20 via network 40, which in various implementations may be a local-area network (LAN), or a wide-area network (WAN) such as the Internet, or some combination of these network types.

In an example of the operation of the system depicted in FIG. 1A, disk wipe manager 12 causes server 10 to push installation of disk wipe client 22 on host machine 20, and to cause host machine 20 to reboot and run disk wipe client 22, which is to be entirely loaded into the memory of host machine 20. Host machine 20, running under the control of disk wipe client 22, proceeds to issue a series of commands to SSD 30, including erase, write, and read operations, to overwrite the entire storage media of SSD 30 with random, or random-looking data.

FIG. 1B is a simplified diagram illustrating the basic architectural organization of SSD 30. Bits of information are stored as charges in capacitive data-storage cells 102 implemented using floating-gate transistors. Cells 102 may each store one, or multiple, bits of information using two or more voltage levels. The storage media is organized into groups of interconnected cells called pages 104. Pages 104 are typically 4-32 KB in data-storage capacity, though a much smaller quantity of cells per page is depicted in FIG. 1B for clarity. Pages 104 are grouped into blocks 106, with each block 106 containing a set of pages, typically numbering between 256 and 512 pages per block. Blocks may be further distributed over multiple dies (not shown), with each die being independently and simultaneously controllable by flash memory controller 110.

SSDs, such as SSD 30, do not read and write bits or bytes of information individually; rather, data is read and written as entire pages 104. Once written, pages 104 cannot be overwritten without first being erased. Moreover, pages 104 are not individually erasable; the minimum erasable unit is block 106, in which the pages 104 are only erasable all together. Thus, for example, changing the value of a single byte of data may involve copying the entire block 106 of pages 104 (in which one page 104 contains the byte) into a memory, marking the block as stale (subject to deletion), updating the byte, and writing the block of data with the updated byte to another location in the SSD. Before the stale block may be reused for storing other data, it must undergo an erase operation, which tends to be substantially slower than a read or write operation. Another characteristic of SSDs is the data-storage cells have a limited number of write/erase cycles in their useful life.

A number of performance optimizations may be implemented by controller 110 to reduce the frequency of the data copying and erasing operations. For instance, controller 110 may be designed to optimize performance and reliability by caching data to be written in local SSD memory (not shown), combining data into pages 104 and blocks 106 to reduce the quantity and frequency of write/erase cycles, perform garbage collection to erase stale blocks during idle periods, and to perform wear-leveling to extend the life of the storage cells by evenly distributing the write/erase operations over the entire SSD.

From the perspective of the host system. SSDs appear as having layouts similar to traditional HDDs, where stored data may be addressed by logical blocks. Logical block size in SSDs is typically 512 bytes, though in some SSDs configured for use in disk arrays logical blocks of 520 or 522 bytes may be defined, with the additional bytes per block being used to store array administration-related data. Although SSDs may appear from the host system's perspective as resembling traditional HDDs, internally, SSDs are organized quite differently. Notably, a given logical block may point to different physical storage elements over time as the SSD erases blocks and re-writes data, performs garbage collection, and the like. Also, notably, SSDs tend to have additional flash data storage than the SSD storage capacity that is presented to the host, which is used for data-storage-location swapping, and the like.

Some SSDs may further optimize operations by checking to see if data to be written to the SSD is already present before performing the write operation. In case a logical block of data is already present, controller 110 may index the storage location of that logical block in lieu of writing the same data to a separate location. FIG. 1C is a flow diagram illustrating an example of this type of storage and performance optimization. At 152, controller 110 may receive data to be written. At 154, controller 110 searches for existing one or more logical blocks containing at least a portion of the data to be written. Controller 110 may have specialized hardware resources to perform this operation quickly.

At decision 156, if a logical block of data is found that matches a portion of the data to be written, the process advances to 158, where controller 110 maps a logical address associated with the data to be written to the location of the existing page. If an existing one or more logical block to be reused is not found for any portion of the data to be written, the process advances to 160, where controller 110 finds or prepares an available physical storage location for the data to be written. At 162, the data is written to the physical storage location, and at 164 the logical address of the written data is associated with its physical location.

In the context of disk wiping of a SSD, performance or storage optimizations such as the example of FIG. 1C may prevent the wiping operation from erasing, and then writing over each working data-storage cell of the SSD to ensure complete and certifiable data wiping.

One aspect of the embodiments provides a solution that ensures data to be written to a SSD is unique for each logical block of the SSD. The solution may be implemented on server 10, host machine 20, or on a combination of these (and, optionally, of other) computing platforms.

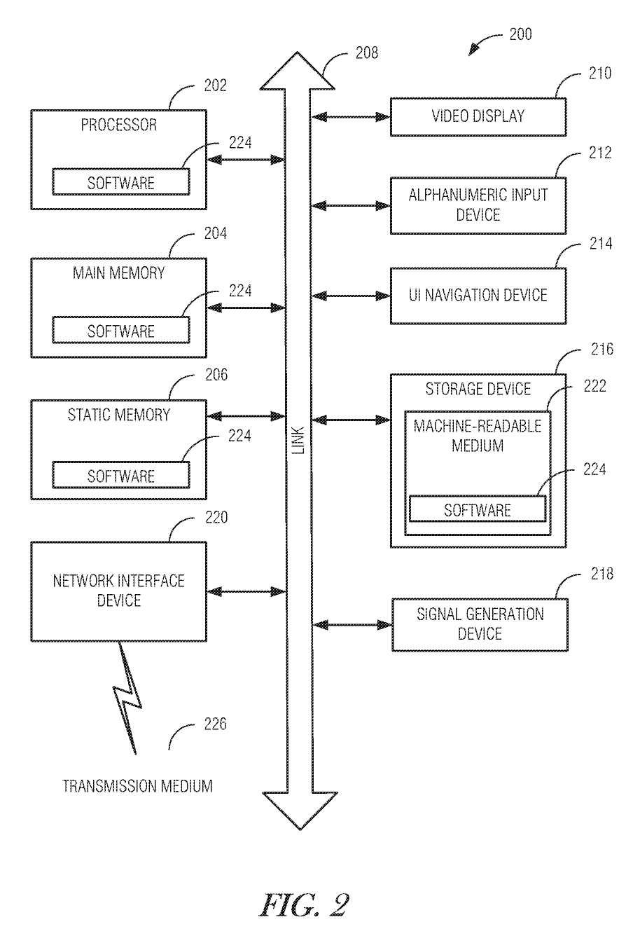

FIG. 2 is a block diagram illustrating a basic architecture of a computing platform in the example form of a general-purpose machine. In certain embodiments, programming of the computer system 200 according to one or more particular algorithms produces a special-purpose machine upon execution of that programming. In a networked deployment, the computer system 200 may operate in the capacity of either a server or a client machine in server-client network environments, or it may act as a peer machine in peer-to-peer (or distributed) network environments. The computer system 200 may take any suitable form factor, such as a personal computer (PC) workstation, a server, whether rack-mounted, or stand-alone, a mainframe computer, a cluster computing system, or the like, a specialized computing appliance, or portable computing system, such as a laptop/notebook PC, a tablet PC, a hybrid tablet, a personal digital assistant (PDA), a mobile telephone or, more generally, any machine capable of executing instructions (sequential or otherwise) that specify actions to be taken by that machine.

Example computer system 200 includes at least one processor 202 (e.g., a central processing unit (CPU), a graphics processing unit (GPU) or both, processor cores, compute nodes, etc.), a main memory 204 and a static memory 206, which communicate with each other via a link 208 (e.g., bus). The computer system 200 may further include a video display unit 210, an alphanumeric input device 212 (e.g., a keyboard), and a user interface (UI) navigation device 214 (e.g., a mouse). In an embodiment, the video display unit 210, input device 212 and UI navigation device 214 are incorporated into a touch screen display. The computer system 200 may additionally include a storage device 216 (e.g., a drive unit), a signal generation device 218 (e.g., a speaker), a network interface device (NID) 220, and one or more sensors (not shown), such as a global positioning system (GPS) sensor, compass, accelerometer, or other sensor.

The storage device 216 includes a machine-readable medium 222 on which is stored one or more sets of data structures and instructions 224 (e.g., software) embodying or utilized by any one or more of the methodologies or functions described herein. The instructions 224 may also reside, completely or at least partially, within the main memory 204, static memory 206, and/or within the processor 202 during execution thereof by the computer system 200, with the main memory 204, static memory 206, and the processor 202 also constituting machine-readable media.

While the machine-readable medium 222 is illustrated in an example embodiment to be a single medium, the term “machine-readable medium” may include a single medium or multiple media (e.g., a centralized or distributed database, and/or associated caches and servers) that store the one or more instructions 224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

NID 220 according to various embodiments may take any suitable form factor. In one such embodiment, NID 220 is in the form of a network interface card (NIC) that interfaces with processor 202 via link 208. In one example, link 208 includes a PCI Express (PCIe) bus, including a slot into which the NIC form-factor may removably engage. In another embodiment, NID 220 is a network interface circuit laid out on a motherboard together with local link circuitry, processor interface circuitry, other input/output circuitry, memory circuitry, storage device and peripheral controller circuitry, and the like. In another embodiment, NID 220 is a peripheral that interfaces with link 208 via a peripheral input/output port such as a universal serial bus (USB) port. NID 220 transmits and receives data over transmission medium 226, which may be wired or wireless (e.g., radio frequency, infra-red or visible light spectra, etc.), fiber optics, or the like.

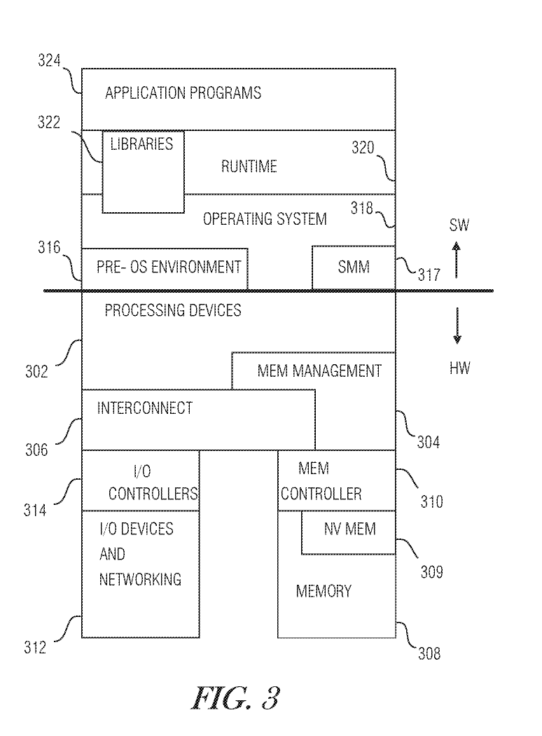

FIG. 3 is a diagram illustrating an exemplary hardware and software architecture of a computing device such as the one depicted in FIG. 2, in which various interfaces between hardware components and software components are shown. As indicated by HW, hardware components are represented below the divider line, whereas software components denoted by SW reside above the divider line. On the hardware side, processing devices 302 (which may include one or more microprocessors, digital signal processors, etc., each having one or more processor cores) are interfaced with memory management device 304 and system interconnect 306. Memory management device 304 provides mappings between virtual memory used by processes being executed, and the physical memory. Memory management device 304 may be an integral part of a central processing unit which also includes the processing devices 302.

Interconnect 306 includes a backplane such as memory, data, and control lines, as well as the interface with input/output devices, e.g., PCI, USB, etc. Memory 308 (e.g., dynamic random access memory—DRAM) and non-volatile memory 309 such as flash memory (e.g., electrically-erasable read-only memory—EEPROM, NAND Flash, NOR Flash, etc.) are interfaced with memory management device 304 and interconnect 306 via memory controller 310. This architecture may support direct memory access (DMA) by peripherals in some embodiments. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 312, which interface with interconnect 306 via corresponding I/O controllers 314.

On the software side, a pre-operating system (pre-OS) environment 316, which is executed at initial system start-up and is responsible for initiating the boot-up of the operating system. One traditional example of pre-OS environment 316 is a system basic input/output system (BIOS). In present-day systems, a unified extensible firmware interface (UEFI) is implemented. Pre-OS environment 316, is responsible for initiating the launching of the operating system, but also provides an execution environment for embedded applications according to certain aspects of the invention.

System management mode (SMM) represents code executed in a special-purpose operating mode of processing devices 302 that is provided for handling system-wide functions like power management, system hardware control, or proprietary OEM designed code. In general, SMM is intended for use by system firmware, not by applications software or general-purpose systems software, though SMM may be called by a system management interrupt (SMI) initiated by the software stack. SMM provides a distinct and isolated processor environment that operates transparently to the operating system or executive and software applications. Processing devices 302 execute the SMM code in a separate address space that is inaccessible to other operating modes of the processing devices 302.

Operating system (OS) 318 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 318 provides device drivers, and a variety of common services such as those that facilitate interfacing with peripherals and networking, that provide abstraction for application programs so that the applications do not need to be responsible for handling the details of such common operations. Operating system 318 additionally provides a graphical user interface (GUI) that facilitates interaction with the user via peripheral devices such as a monitor, keyboard, mouse, microphone, video camera, touchscreen, and the like.

Runtime system 320 implements portions of an execution model, including such operations as putting parameters onto the stack before a function call, the behavior of disk input/output (I/O), and parallel execution-related behaviors. Runtime system 320 may also perform support services such as type checking, debugging, or code generation and optimization.

Libraries 322 include collections of program functions that provide further abstraction for application programs. These include shared libraries, dynamic linked libraries (DLLs), for example. Libraries 322 may be integral to the operating system 318, runtime system 320, or may be added-on features, or even remotely-hosted. Libraries 322 define an application program interface (API) through which a variety of function calls may be made by application programs 324 to invoke the services provided by the operating system 318. Application programs 324 are those programs that perform useful tasks for users, beyond the tasks performed by lower-level system programs that coordinate the basis operability of the computing device itself.

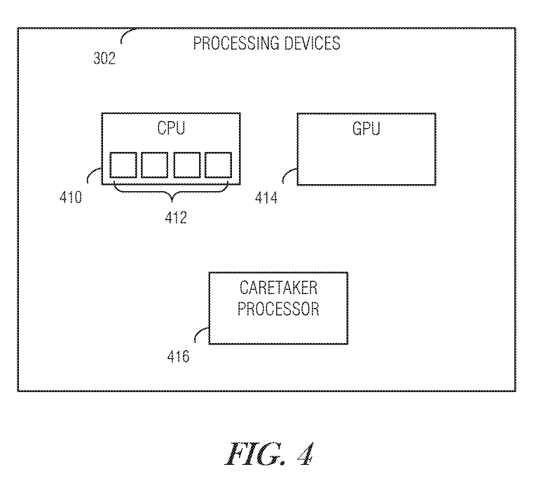

FIG. 4 is a block diagram illustrating processing devices 302 according to some embodiments. CPU 410 may contain one or more processing cores 412. As an illustrative example, CPU 410 may be a x86-type of processor. Processing devices 302 may also include a graphics processing unit (GPU) 414. In these embodiments, GPU 414 may be a specialized co-processor that offloads certain computationally-intensive operations, particularly those associated with graphics rendering, from CPU 410. Notably, CPU 410 and GPU 414 generally work collaboratively, sharing access to memory resources, I/O channels, etc.

Processing devices 302 also include caretaker processor 416. Caretaker processor 416 generally does not participate in the processing work to carry out software code as CPU 410 and GPU 414 do. In some embodiments, caretaker processor 416 does not share memory space with CPU 410 and GPU 414, and is therefore not arranged to execute operating system or application programs. Instead, caretaker processor 416 may execute dedicated firmware that supports the technical workings of CPU 410, GPU 414, and other components of the computer system. In some embodiments, caretaker processor is implemented as a microcontroller device, which may be physically present on the same integrated circuit die as CPU 410, or may be present on a distinct integrated circuit die. Caretaker processor 416 may also include a dedicated set of I/O facilities to enable it to communicate with external entities. In one type of embodiment, caretaker processor 416 is implemented using a manageability engine (ME) or platform security processor (PSP).

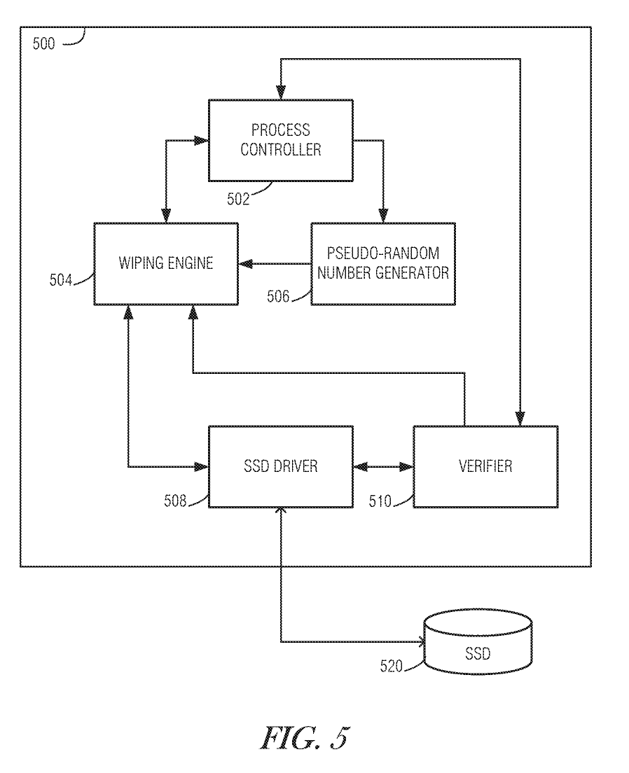

FIG. 5 is a block diagram illustrating example components that may be implemented on a computer system, such as the computer system and components described with reference to FIGS. 2-4, according to various embodiments. Examples, as described herein, may include, or may operate on, logic or a number of components, modules, or engines, which for the sake of consistency are termed engines, although it will be understood that these terms may be used interchangeably. Engines may be hardware, software, or firmware communicatively coupled to one or more processors in order to carry out the operations described herein. Engines may be hardware engines, and as such engines may be considered tangible entities capable of performing specified operations and may be configured or arranged in a certain manner. In an example, circuits may be arranged (e.g., internally or with respect to external entities such as other circuits) in a specified manner as an engine. In an example, the whole or part of one or more computer systems (e.g., a standalone, client or server computer system) or one or more hardware processors may be configured by firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. With reference to FIG. 3, for instance, an engine may include one, or any combination, of the blocks depicted, so long as at least one block from the HW side is included.

Considering examples in which engines are temporarily configured, each of the engines need not be instantiated at any one moment in time. For example, where the engines comprise a general-purpose hardware processor configured using software; the general-purpose hardware processor may be configured as respective different engines at different times. Software may accordingly configure a hardware processor, for example, to constitute a particular engine at one instance of time and to constitute a different engine at a different instance of time.

Turning now to the details of the example system, the hardware and software components of a host computer system are operative (e.g., configured, programmed, arranged, etc., to be operational when activated), to implement drive wiping system 500. In various examples, system 500 is implemented by a single computer system; in other embodiments, certain operations may be distributed between multiple computer systems using client-server, peer-peer, cloud, or other distributed computing model. For instance, referring to FIG. 1A, portions of system 500 may be executed by server 10, while other portions may be executed by host machine 20.

System 500 includes process controller 502, wiping engine 504, pseudo-random number generator (PRNG) 506, drive interface 508, and verifier 510. Process controller 502 coordinates the operation of drive wiping system 500 by signaling commands to wiping engine 504 and PRNG 506, receiving feedback information from verifier 510, to execute a drive wiping algorithm, examples of which are described below.

Wiping engine 504 is constructed, programmed, or otherwise configured, to issue read, write, delete and, optionally, other commands to SSD 520 in furtherance of the drive wiping protocol to be carried out. In general, drive wiping engine 504, under control of process controller 502, sends commands to assess the parameters of SSD 520, such as logical block size, page size, block size, drive capacity, bad logical addresses, and the like, to delete stored data, to write “wiping” data consisting of random, or random-looking, data to logical addresses until the drive is entirely filled with the wipe data, to retry writes in response to errors, and to repeat the erasing and writing of wipe data as additional wiping passes over the drive to ensure that all available data storage cells of the media of SSD 520 are exercised and written with wiping data.

PRNG 506 produces the wiping data. Notably, the wiping data is random-like data such that it contains no discernable informational content. In various embodiments, PRNG 506 has a period many orders of magnitude larger than the size of the SDD. For example, the PRNG may have a period of 2¹²⁸−1 states. In a particular example, PNRG 506 may use the Xoroshirol28+ algorithm created by Sebastiano Vigna and David Blackman.

SSD driver 508 is constructed, programmed, or otherwise configured, to send and receive commands, data, and related messaging with SSD 520 over the available drive interface (e.g., SCSI, SATA, SAS, RAID, etc.). Verifier 510 is constructed, programmed, or otherwise configured, to process confirmation, error, and other messages from SSD 520 to determine whether the erase, write, and read operations were successful, and to pass relevant results to process controller 502 or wiping engine 504.

In a related embodiment verifier 510 maintains and updates a running hash of the data written to the SSD. Accordingly, after each write operation, the hash is updated to reflect the totality of the written random-like data. In an example, the hashing algorithm employed is the MurmurHash function, the output of which may be processed with newly-added data to produce an updated hash result reflecting the entire set of written data, without having to re-process the hash of the entire set of written data after each write cycle. When the entire capacity of the SSD is filled with wiping data, the running hash may be compared against a newly-computed hash of the full SSD to ensure that the SSD stores the wiping data free of errors.

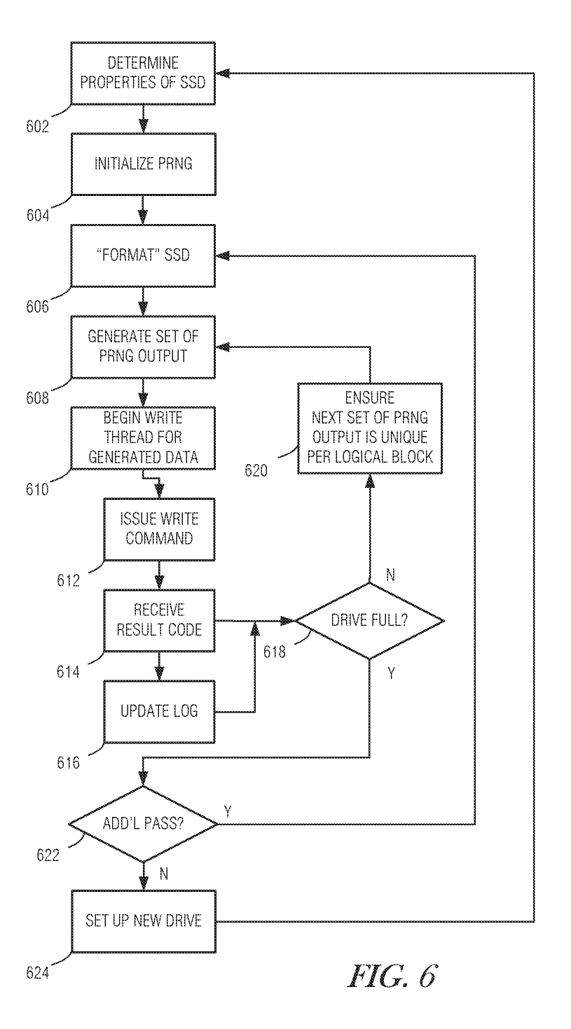

FIG. 6 is a flow diagram illustrating an example process for wiping a SSD, which may be carried out by drive wiping system 500 according to some embodiments. At 602, the system determines the properties of the SSD, such as the logical block size and page size specific to the SSD. Based on this information, wiping data may be fed to the SSD in a series of write operations having a size that matches the page size to simplify the filling of the SSD with wiping data, and to allow the SSD's flash controller to streamline the internal workings of the SSD during the block-erase and page-writing operations.

At 604 the PRNG is initialized. Initialization of the PRNG generally involves resetting the PRNG with a new suitable seed value. The seed value may be based on a parameter specific to the SSD, such as a value formulaically derived from the SSD's serial number (e.g., a 128-bit hash computed from the serial number). In another example, the seed value it may be determined from a system entropy pool of the host machine (e.g., based on a random-value input, such as a voltage measurement, a time lapse measurement between communication events, or the like).

At 606, the system sends a command or series of commands to format, or otherwise delete all of the data stored on the SSD. In response to a “format” command, a SSD will generally not perform block-wise erasures of the entire media; instead, the SSD will mark each block, or each page, as stale, meaning that these locations may be erased as needed.

At 608, the PRNG is used to produce a set of PRNG output. The PRNG output has properties resembling random data (e.g., uniformity, and apparent independence even though the PRNG is, by its nature, deterministic). At 610, the system begins a write operation, which includes operations 612-616. At 612, the system issues a write command to the SSD indicating the starting logical address and the data to be written. The data to be written may have a size that matches the page sizing of the SSD to improve throughput since only a single page is to be written. At 614, the system receives a result code from the SSD indicating whether the write was successful, or whether an error occurred. At 616, based on the result code, a log is updated.

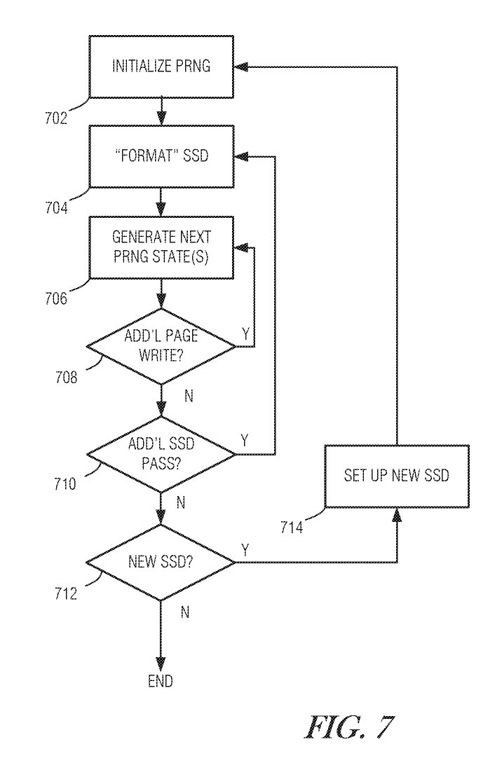

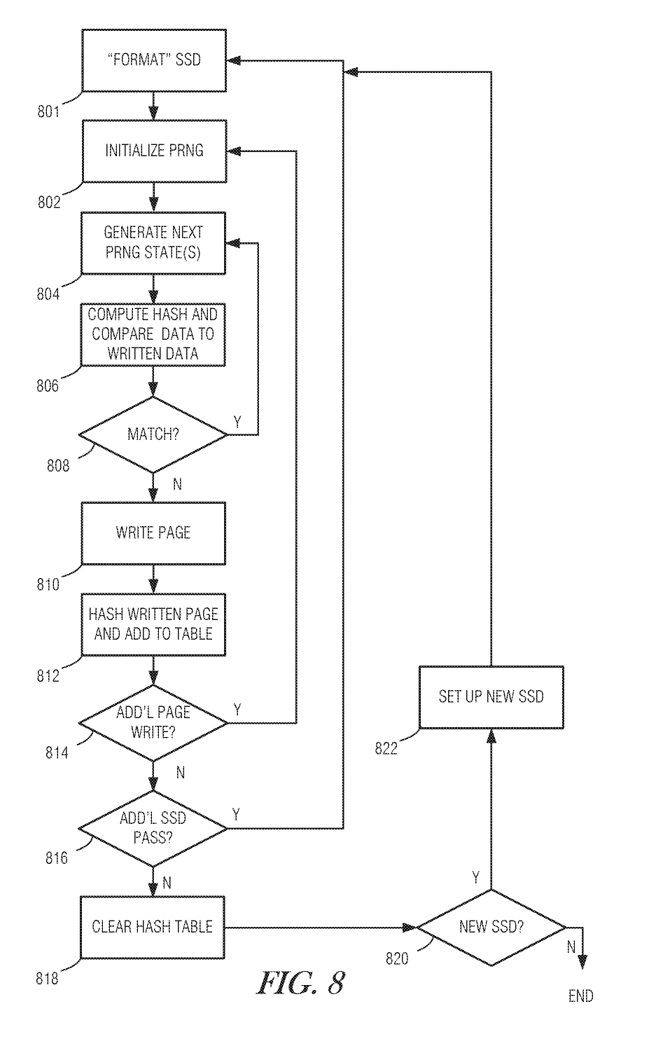

Decision 618 determines whether, as a result of the write command, the drive is full. In the negative case, the process advances to 620, where the system ensures that the next set of PRNG output is unique for each logical block to which the PRNG output is to be written. Various techniques are contemplated for achieving uniqueness of the PRNG output. In one approach, as discussed below with reference to FIG. 7, the system refrains from re-initializing the PRNG during wiping of the SSD. In another approach, as discussed below with reference to FIG. 8, the system actively checks the value of the generated PRNG data to be written to ensure that it is different from logical blocks already written to the SSD. Next, the process loops back to operation 608 to generate the next set of PRNG output, and proceed with another write operation.

If decision 618 determines that the drive is full, the process advances to decision 622 to determine whether an additional wiping pass over the SSD is called for. The number of wiping passes may be variable, and implemented as a configuration setting for the drive wiping routine. Typical numbers of passes are between 3 and 7. A counter may be used by the system to track the pass number and compare the number of actually-completed passes against the number of specified passes to be completed. If an additional pass is called for, the process loops back to 606, where the SSD is formatted for the next wiping pass.

In the example depicted, the PRNG is not re-initialized for subsequent wiping passes of the same SSD. This approach is applicable for PRNGs that provide sufficient periods that exceed the size of the SSD times the number of passes. In other embodiments, the PRNG may be re-initialized with a different seed value than the seed value used previously, in which case a provision is made to ensure that no page is repeated in the ensuing PRNG output.

If decision 622 determines that no further wiping passes are called for, the process advances to 624 to set up a new SSD to be wiped. Setup of a new SSD may involve physically removing the previous SSD and replacing it with the new SSD. In other examples, where the SSD is installed in a wiping appliance that has multiple drive ports, setup of the SSD may involve switching the targeting from the previous drive's addressing to the new SSD's addressing in the appliance. The process may then proceed anew at operation 602 with the new SSD.

FIG. 7 is a flow diagram illustrating operation of the PRNG in SSD wiping process 600 including an example of ensuring that each page written to the SSD is unique, according to an embodiment. In the process of FIG. 7, the PRNG has a period that is at least three orders of magnitude greater than the size of the SSD. Although the PRNG may repeat an individual output value, the probability that an entire page of values is the same as a prior-written page to the same SSD is infinitesimal. This example process relies on the PRNG having properties sufficient to ensure that no page of random-like data is repeated in the SSD wiping routine.

Accordingly, at 702, the PRNG is initialized with a seed value. At 704, the SSD is formatted. At 706, the PRNG generates a set of random-like data for a write operation, which may involve multiple successive PRNG states. The sets of values may amount to a logical block, page, or set of pages of data that is the subject of an upcoming write operation. If an additional page is to be written, as determined at decision 708, the process loops back to 706 for the generation of further random-like data for a subsequent write operation. Otherwise, if the SSD is full, the process advances to decision 710, where the system determines whether an additional wiping pass is called for. In the affirmative case, the process loops to operation 704 to format the SSD and begin writing. Notably, the PRNG is not re-initialized at this stage.

When wiping of the current SSD is complete, decision 712 determines if a new SSD is to be wiped. In this case, the new SSD is set up at 714, and the PRNG is initialized at 702. The new SSD may have a different page size than the previous SSD, in which case the set of random-like data to be generated at 706 would be sized to match the new SSD. Notably, the process refrains from re-initializing the PRNG during the wiping of each given SSD. The PRNG itself is specifically selected to have properties that make it virtually impossible, e.g., a less than 1 ppm chance, that the data of any page write is repeated during the SSD wiping process.

FIG. 8 is a flow diagram illustrating another example operation of the PRNG according to some embodiments. The process of FIG. 8 does not rely on the PRNG having a particularly long period, or other properties, to inherently ensure that pages of random-like data are not repeated. Rather, specialized actions are taken to prevent writing of duplicative page data.

As depicted, the SSD is formatted at 801. At 802, the PRNG is initialized with a seed value. The seed value may be based on an attribute of the SSD, for example. The seed value may also or instead be based on some attribute related to the current wiping pass (e.g., current time, wiping pass number, etc.). In another example, the seed value may be taken from the host machine's entropy pool as a random value.

At 804, the PRNG generates a set of random-like data to be used for a write operation, which may involve progressing through multiple successive states of PRNG output. The set of random-like data may be of a size equal to a logical block, set of logical blocks, page size, or set of pages, of the SSD being wiped. At 806, a hash of a logical block or other addressable unit of random-like data is computed, and this hash is compared against stored data. Various suitable approaches may be used for comparing the hashed value against written data. For instance, in one example, a rolling-hash function, such as a Rabin-Karp algorithm, is applied to random-like data written to the SSD. In another approach, a table containing prior-computed hashes of addressable units of data written to the same SSD is maintained.

At 808, if a match is found between the newly-generated random-like data and data written to the SSD, the generated set of random-like data is not written to the SSD. The process returns to 804 to generate a new set of random-like data for the page write, and the duplicate random-like data is discarded. The generated set of random-like data may be of a logical block size, a page size, or other addressable data unit size. If decision 808 finds that the generated set of random-like data is not duplicative, the data is used for a page write operation to be completed at 810.

In embodiments utilizing a hash table, at 812 hash(es) of the written addressable units of data are added to the hash table. The hash table may be stored in the memory of the host machine, or on a separate drive that is not the subject of the wipe operation. The hash table may also be stored on a remote machine, such as a server that can be queried by the host system. Portions of the hash table, such as truncated hashes (e.g., the 10 most-significant or least-significant bits), algorithmically-extracted parts of hashes (e.g., every 10^{th} bit), or an indexing data structure, may be stored locally on the host machine to speed up the hash table lookups and reduce the storage space for the hash table.

In another embodiment, the hash table may be written to the SSD as part of the wiping data. This approach may be used in embodiments where the hashing algorithm produces hashes that have random-like properties. In a related embodiment, pages of the SSD that are filled with hashes are themselves hashed, with those hashes of hashes added to the hash table. Thus, in this type of embodiment, the hash table constitutes a portion of the wiping data.

In a related embodiment, the hash table lookups may be performed for groups of hashes, rather than individually. Thus, random-like data may be generated in advance for a group of write operations, such as for 1000 pages. Each page of that data may be hashed, and these hashes may be subgrouped (such as by the most-significant bits, etc. Each subgroup of hashes may be looked up together in the hash table, or the entire set of hashes may be looked up in a multi-query that is transmitted to the server or entity containing the hash table in a single session. The random-like data corresponding to those hashes that have not been found in the hash table may be sent to the SSD individually at 810 for writing.

At 814, a decision is made as to whether an additional page (or group of pages) is to be written. In this case, the process loops to 802 to re-initialize the PRNG with a different seed value than used previously. If no more pages are to be written, decision 816 determines whether an additional wiping pass of the SSD is called for. In the affirmative case, the process loops back to 801 to format the SSD.

If no further wiping passes are called for, at 818 the hash table, and portions of the hash table stored in memory of the host machine or elsewhere, may be cleared. Clearing of the hash table applies where the hash table is not part of the wiping data. Decision 820 determines whether a new SSD is to be wiped. In the affirmative case, the new SSD is set up at 822, and the process loops back to 801 to initiate formatting of the new SSD.

In a related embodiment, the PRNG may be re-initialized more frequently, such as after the filling of some specified number of pages, after filling some specified number of blocks, etc. In re-initializing the PRNG during the wiping of a given SSD, the PRNG is initialized with a seed value that differs from the seed value used previously for the same SSD.

Example embodiments of the inventive concepts include the following:

Example 1 is a system for data wiping of a solid-state drive (SSD), the system comprising: a pseudo-random number generator (PRNG) to generate random-like data in successive states; a wiping engine to generate write commands to the SSD to write the output of the PRNG; and a controller to coordinate operation of the PRNG and the wiping engine, wherein the controller is to: initialize the PRNG with a first seed value; and ensure that each of the write commands contains at least one addressable data unit of PRNG output to be written to the SSD that is different from any previously-written addressable data unit of PRNG output to the SSD.

In Example 2, the subject matter of Example 1 optionally includes wherein the wiping engine is to determine properties of the SSD including a size of the addressable data unit of the SSD, prior to generation of the wipe commands.

In Example 3, the subject matter of any one or more of Examples 1-2 optionally include wherein the addressable data unit is a logical block.

In Example 4, the subject matter of any one or more of Examples 1-3 optionally include wherein the addressable data unit is a page.

In Example 5, the subject matter of any one or more of Examples 1-4 optionally include

In Example 6, the subject matter of Example 5 optionally includes + algorithm.

In Example 7, the subject matter of any one or more of Examples 1-6 optionally include wherein to ensure that each of the write commands contains at least one addressable data unit of PRNG output to be written to the SSD that is different from any previously-written addressable data unit of PRNG output to the SSD, the controller refrains from re-initializing the PRNG until completion of the data wiping of the SSD.

In Example 8, the subject matter of any one or more of Examples 1-7 optionally include wherein to ensure that each of the write commands contains at least one addressable data unit of PRNG output to be written to the SSD that is different from any previously-written addressable data unit of PRNG output to the SSD, the controller re-initializes the PRNG prior to completion of the data wiping of the SSD using a new seed value that differs from the first seed value and from any other seed value used previously to re-initialize the PRNG during the data wiping of the SSD.

In Example 9, the subject matter of any one or more of Examples 1-8 optionally include ppm probability of being the same as any prior-written addressable data unit on the SSD based on the PRNG output.

In Example 10, the subject matter of any one or more of Examples 1-9 optionally include wherein to ensure that each of the write commands contains at least one addressable data unit of PRNG output to be written to the SSD that is different from any previously-written addressable data unit of PRNG output to the SSD, the controller generates a hash of each addressable data unit of PRNG output to be written to the SSD, and compares that hash against a hash table of hashes previously written to the SSD, wherein PRNG output data corresponding to a hash matching any hash of the hash table is omitted from being written to the SSD.

In Example 11, the subject matter of any one or more of Examples 1-10 optionally include wherein to ensure that each of the write commands contains at least one addressable data unit of PRNG output to be written to the SSD that is different from any previously-written addressable data unit of PRNG output to the SSD the controller generates a hash of each addressable data unit of PRNG output written to the SSD, and stores that hash in a hash table.

In Example 12, the subject matter of Example 11 optionally includes wherein the hash table is stored on the SSD.

In Example 13, the subject matter of any one or more of Examples 1-12 optionally include wherein the write commands are each page-wise write commands containing PRNG output of a size corresponding to a determined page size of the SSD.

In Example 14, the subject matter of any one or more of Examples 1-13 optionally include wherein the first seed value is based on an attribute of the SSD.

In Example 15, the subject matter of Example 14 optionally includes wherein the first seed value is based on a random value.

In Example 16, the subject matter of any one or more of Examples 14-15 optionally include wherein the controller is to cause the system to: perform multiple wiping passes on the SSD, each wiping pass including erasure and re-writing of PRNG output data over the SSD; and wherein the first seed value is based further on an attribute relating to a current wiping pass from among the multiple wiping passes.

In Example 17, the subject matter of any one or more of Examples 1-16 optionally include a verifier to maintain a running hash representing a totality of data written to the SSD as a result of the write commands, wherein the running hash is updated following each latest write command based on a previous hash value of the running hash and on a hash-function-processed output of the data written by the latest write command.

Example 18 is a at least one non-transitory machine-readable medium comprising instructions that, when executed by a processor of a SSD-wiping system, cause the SSD wiping system to: initialize a pseudo-random number generator (PRNG) with a first seed value; generate random-like data as output of the PRNG; and generate write commands to the SSD to write the output of the PRNG while ensuring that each of the write commands contains at least one addressable data unit of PRNG output to be written to the SSD that is different from any previously-written addressable data unit of PRNG output to the SSD.

In Example 19, the subject matter of Example 18 optionally includes wherein the instructions are to cause the SSD wiping system, prior to generating the wipe commands, determine properties of the SSD including a size of the addressable data unit of the SSD.

In Example 20, the subject matter of any one or more of Examples 18-19 optionally include wherein the addressable data unit is a logical block.

In Example 21, the subject matter of any one or more of Examples 18-20 optionally include wherein the addressable data unit is a page.

In Example 22, the subject matter of any one or more of Examples 18-21 optionally include

In Example 23, the subject matter of Example 22 optionally includes + algorithm.

In Example 24, the subject matter of any one or more of Examples 18-23 optionally include wherein ensuring that each of the write commands contains at least one addressable data unit of PRNG output to be written to the SSD that is different from any previously-written addressable data unit of PRNG output to the SSD includes refraining from re-initializing the PRNG until completion of the data wiping of the SSD.

In Example 25, the subject matter of any one or more of Examples 18-24 optionally include wherein ensuring that each of the write commands contains at least one addressable data unit of PRNG output to be written to the SSD that is different from any previously-written addressable data unit of PRNG output to the SSD includes re-initializing the PRNG prior to completion of the data wiping of the SSD using a new seed value that differs from the first seed value and from any other seed value used previously to re-initialize the PRNG during the data wiping of the SSD.

In Example 26, the subject matter of any one or more of Examples 18-25 optionally include ppm probability of being the same as any prior-written addressable data unit on the SSD based on the PRNG output.

In Example 27, the subject matter of any one or more of Examples 18-26 optionally include wherein ensuring that each of the write commands contains at least one addressable data unit of PRNG output to be written to the SSD that is different from any previously-written addressable data unit of PRNG output to the SSD includes generating a hash of each addressable data unit of PRNG output to be written to the SSD, and comparing that hash against a hash table of hashes previously written to the SSD, wherein PRNG output data corresponding to a hash matching any hash of the hash table is omitted from being written to the SSD.

In Example 28, the subject matter of any one or more of Examples 18-27 optionally include wherein ensuring that each of the write commands contains at least one addressable data unit of PRNG output to be written to the SSD that is different from any previously-written addressable data unit of PRNG output to the SSD includes generating a hash of each addressable data unit of PRNG output written to the SSD, and storing that hash in a hash table.

In Example 29, the subject matter of Example 28 optionally includes wherein the hash table is stored on the SSD.

In Example 30, the subject matter of any one or more of Examples 18-29 optionally include wherein the write commands are each page-wise write commands containing PRNG output of a size corresponding to a determined page size of the SSD.

In Example 31, the subject matter of any one or more of Examples 18-30 optionally include wherein the first seed value is based on an attribute of the SSD.

In Example 32, the subject matter of Example 31 optionally includes wherein the first seed value is based on a random value.

In Example 33, the subject matter of any one or more of Examples 31-32 optionally include wherein the instructions are to cause the SSD wiping system to perform multiple wiping passes on the SSD, each wiping pass including erasure and re-writing of PRNG output data over the SSD; and wherein the first seed value is based further on an attribute relating to a current wiping pass from among the multiple wiping passes.

In Example 34, the subject matter of any one or more of Examples 18-33 optionally include wherein the instructions are to cause the SSD wiping system to maintain a running hash representing a totality of data written to the SSD as a result of the write commands, wherein the running hash is updated following each latest write command based on a previous hash value of the running hash and on a hash-function-processed output of the data written by the latest write command.

Example 35 is a method for data wiping of a solid-state drive (SSD), the method being carried out autonomously by a SSD wiping machine, the method comprising: initializing a pseudo-random number generator (PRNG) with a first seed value; generating random-like data as output of the PRNG; generating write commands to the SSD to write the output of the PRNG; and in generating the write commands, ensuring that each of the write commands contains at least one addressable data unit of PRNG output to be written to the SSD that is different from any previously-written addressable data unit of PRNG output to the SSD.

In Example 36, the subject matter of Example 35 optionally includes prior to generating the wipe commands, determining properties of the SSD including a size of the addressable data unit of the SSD.

In Example 37, the subject matter of any one or more of Examples 35-36 optionally include wherein the addressable data unit is a logical block.

In Example 38, the subject matter of any one or more of Examples 35-37 optionally include wherein the addressable data unit is a page.

In Example 39, the subject matter of any one or more of Examples 35-38 optionally include

In Example 40, the subject matter of Example 39 optionally includes + algorithm.

In Example 41, the subject matter of any one or more of Examples 35-40 optionally include wherein ensuring that each of the write commands contains at least one addressable data unit of PRNG output to be written to the SSD that is different from any previously-written addressable data unit of PRNG output to the SSD includes refraining from re-initializing the PRNG until completion of the data wiping of the SSD.

In Example 42, the subject matter of any one or more of Examples 35-41 optionally include wherein ensuring that each of the write commands contains at least one addressable data unit of PRNG output to be written to the SSD that is different from any previously-written addressable data unit of PRNG output to the SSD includes re-initializing the PRNG prior to completion of the data wiping of the SSD using a new seed value that differs from the first seed value and from any other seed value used previously to re-initialize the PRNG during the data wiping of the SSD.

In Example 43, the subject matter of any one or more of Examples 35-42 optionally include ppm probability of being the same as any prior-written addressable data unit on the SSD based on the PRNG output.

In Example 44, the subject matter of any one or more of Examples 35-43 optionally include wherein ensuring that each of the write commands contains at least one addressable data unit of PRNG output to be written to the SSD that is different from any previously-written addressable data unit of PRNG output to the SSD includes generating a hash of each addressable data unit of PRNG output to be written to the SSD, and comparing that hash against a hash table of hashes previously written to the SSD, wherein PRNG output data corresponding to a hash matching any hash of the hash table is omitted from being written to the SSD.

In Example 45, the subject matter of any one or more of Examples 35-44 optionally include wherein ensuring that each of the write commands contains at least one addressable data unit of PRNG output to be written to the SSD that is different from any previously-written addressable data unit of PRNG output to the SSD includes generating a hash of each addressable data unit of PRNG output written to the SSD, and storing that hash in a hash table.

In Example 46, the subject matter of Example 45 optionally includes wherein the hash table is stored on the SSD.

In Example 47, the subject matter of any one or more of Examples 35-46 optionally include wherein the write commands are each page-wise write commands containing PRNG output of a size corresponding to a determined page size of the SSD.

In Example 48, the subject matter of any one or more of Examples 35-47 optionally include wherein the first seed value is based on an attribute of the SSD.

In Example 49, the subject matter of Example 48 optionally includes wherein the first seed value is based on a random value.

In Example 50, the subject matter of any one or more of Examples 48-49 optionally include performing multiple wiping passes on the SSD, each wiping pass including erasure and re-writing of PRNG output data over the SSD; and wherein the first seed value is based further on an attribute relating to a current wiping pass from among the multiple wiping passes.

In Example 51, the subject matter of any one or more of Examples 35-50 optionally include maintaining a running hash representing a totality of data written to the SSD as a result of the write commands, wherein the running hash is updated following each latest write command based on a previous hash value of the running hash and on a hash-function-processed output of the data written by the latest write command.

Example 52 is a system for data wiping of a solid-state drive (SSD), the system comprising: means for initializing a pseudo-random number generator (PRNG) with a first seed value; means for generating random-like data as output of the PRNG; means for generating write commands to the SSD to write the output of the PRNG; and means for ensuring that each of the write commands contains at least one addressable data unit of PRNG output to be written to the SSD that is different from any previously-written addressable data unit of PRNG output to the SSD.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second.” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A system for data wiping of a solid-state drive (SSD), the system comprising:
a computing platform, including at least one processor circuit, data storage circuitry, and input/output circuitry including a SSD interface, the computing platform being configured to implement:
a pseudo-random number generator (PRNG) to generate random-like data in successive states, wherein the PRNG has a period that is greater than a total capacity of the SSD by a factor of at least 1000;
a wiping engine to generate multiple passes of write commands over the entire SSD to write the output of the PRNG, each wiping pass including erasure and re-writing of PRNG output data over the SSD; and
a controller to coordinate operation of the PRNG and the wiping engine, wherein the controller is to:
initialize the PRNG with a first seed value;
refrain from re-initializing the PRNG until completion of the multiple passes of the data-wiping operations to ensure that each of the write commands contains at least one addressable data unit of PRNG output to be written to the SSD that is different from any previously-written addressable data unit of PRNG output to the SSD; and
a verifier engine to maintain a running hash representing a totality of data written to the SSD as a result of the write commands, wherein the running hash is updated following each latest write command based on a previous hash value of the running hash and on a hash-function-processed output of the data written by the latest write command and, following completion of the multiple passes of write commands, to compute a verification hash of the entire SSD and compare the verification hash against the running hash to produce a verification result.

2. (canceled)

3. The system of claim 1, wherein the PRNG executes a Xoroshirol28+ algorithm.

4-5. (canceled)

6. The system of claim 1, wherein to ensure that each of the write commands contains at least one addressable data unit of PRNG output to be written to the SSD that is different from any previously-written addressable data unit of PRNG output to the SSD, the PRNG generates addressable data units of PRNG output to be written to the SSD that have a less than 1 ppm probability of being the same as any prior-written addressable data unit on the SSD based on the PRNG output.

7-10. (canceled)

11. At least one non-transitory machine-readable medium comprising instructions that, when executed by a processor of a SSD-wiping system, cause the SSD wiping system to:
initialize a pseudo-random number generator (PRNG) with a first seed value, wherein the PRNG has a period that is greater than a total capacity of the SSD by a factor of at least 1000;
generate random-like data as output of the PRNG;
generate multiple passes of write commands over the entire SSD to write the output of the PRNG each wiping pass including erasure and re-writing of PRNG output data over the SSD:
refrain from re-initializing the PRNG until completion of the multiple passes of the data-wiping operations to ensure that each of the write commands contains at least one addressable data unit of PRNG output to be written to the SSD that is different from any previously-written addressable data unit of PRNG output to the SSD; and
maintain a running hash representing a totality of data written to the SSD as a result of the write commands, wherein the running hash is updated following each latest write command based on a previous hash value of the running hash and on a hash-function-processed output of the data written by the latest write command and, following completion of the multiple passes of write commands, to compute a verification hash of the entire SSD and compare the verification hash against the running hash to produce a verification result.

12-14. (canceled)

15. The at least one non-transitory machine-readable medium of claim 11, wherein ensuring that each of the write commands contains at least one addressable data unit of PRNG output to be written to the SSD that is different from any previously-written addressable data unit of PRNG output to the SSD includes generating addressable data units of PRNG output to be written to the SSD that have a less than 1 ppm probability of being the same as any prior-written addressable data unit on the SSD based on the PRNG output.

16. (canceled)

18. A method for data wiping of a solid-state drive (SSD), the method being carried out autonomously by a SSD wiping machine, the method comprising:
initializing a pseudo-random number generator (PRNG) with a first seed value, wherein the PRNG has a period that is greater than a total capacity of the SSD by a factor of at least 1000;
generating random-like data as output of the PRNG;
generating multiple passes of write commands over the entire SSD to write the output of the PRNG each wiping pass including erasure and re-writing of PRNG output data over the SSD;
refraining from re-initializing the PRNG until completion of the multiple passes of the data-wiping operations to ensure that each of the write commands contains at least one addressable data unit of PRNG output to be written to the SSD that is different from any previously-written addressable data unit of PRNG output to the SSD; and
maintaining a running hash representing a totality of data written to the SSD as a result of the write commands, wherein the running hash is updated following each latest write command based on a previous hash value of the running hash and on a hash-function-processed output of the data written by the latest write command and, following completion of the multiple passes of write commands, to compute a verification hash of the entire SSD and compare the verification hash against the running hash to produce a verification result.

19. (canceled)

20. The method of claim 18, wherein ensuring that each of the write commands contains at least one addressable data unit of PRNG output to be written to the SSD that is different from any previously-written addressable data unit of PRNG output to the SSD includes generating addressable data units of PRNG output to be written to the SSD that have a less than 1 ppm probability of being the same as any prior-written addressable data unit on the SSD based on the PRNG output.
